(19) United States
(12) Patent Application Publication
(10) Pub. No.: US 2023/0013048 A1
(43) Pub. Date: Jan. 19, 2023

(54) HANDLING PARTITION DATA

(71) Applicant: International Business Machines Corporation, Armonk, NY (US)

(72) Inventors: Shuo Li, Beijing (CN); Jia Tian Zhong, Beijing (CN); Xiaobo Wang, Beijing (CN); Sheng Yan Sun, BeiJing (CN)

(21) Appl. No.: 17/377,965

(22) Filed: Jul. 16, 2021

(51) Int. Cl. G06F 3/06

(52) U.S. Cl. CPC G06F 3/0644; G06F 3/0604; G06F 3/0674

(57) ABSTRACT

Determining which data should be located in each partition of a hard disk drive storage device based on growth values and/or data access frequency values.

### BACKGROUND

The present invention relates generally to the field of partitioning of hard disk drives that store digital data in separate and distinct partitions.

The Wikipedia entry for “disk partitioning” (as of 6 Jun. 2021) states, in part, as follows: “Disk partitioning or disk slicing is the creation of one or more regions on secondary storage, so that each region can be managed separately. These regions are called partitions. It is typically the first step of preparing a newly installed disk, before any file system is created. The disk stores the information about the partitions' locations and sizes in an area known as the partition table that the operating system reads before any other part of the disk. Each partition then appears to the operating system as a distinct “logical” disk that uses part of the actual disk. System administrators use a program called a partition editor to create, resize, delete, and manipulate the partitions. Partitioning allows the use of different filesystems to be installed for different kinds of files. Separating user data from system data can prevent the system partition from becoming full and rendering the system unusable. Partitioning can also make backing up easier. A disadvantage is that it can be difficult to properly size partitions, resulting in having one partition with too much free space and another nearly totally allocated.” (footnotes omitted)

### SUMMARY

According to an aspect of the present invention, there is a method, computer program product and/or system that performs the following operations (not necessarily in the following order): (i) receive a request to partition a hard disk storage device, with the hard disk drive storage device having stored thereon a plurality of data portions, with each data portion of the plurality of data portions including at least one bit of data; (ii) determining a number of partitions, N, to use in the requested partitioning operation, where N is an integer greater than one; (iii) for each given partition to be created responsive to the requested partitioning operation, determining a range of access frequency values (and/or growth values) characteristic of data to be stored in the given partition; (iv) for each given data portion of the plurality of data portions, determining an associated access frequency value (and/or growth value) based on access operations that involved data included in the given data portion; and (v) partitioning the hard disk drive storage device so that each given data portion is stored in a partition characterized by a range of access frequency values (and/or growth values) which includes the access frequency values characterizing the given data portion.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a block diagram helpful in understanding various embodiments of the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

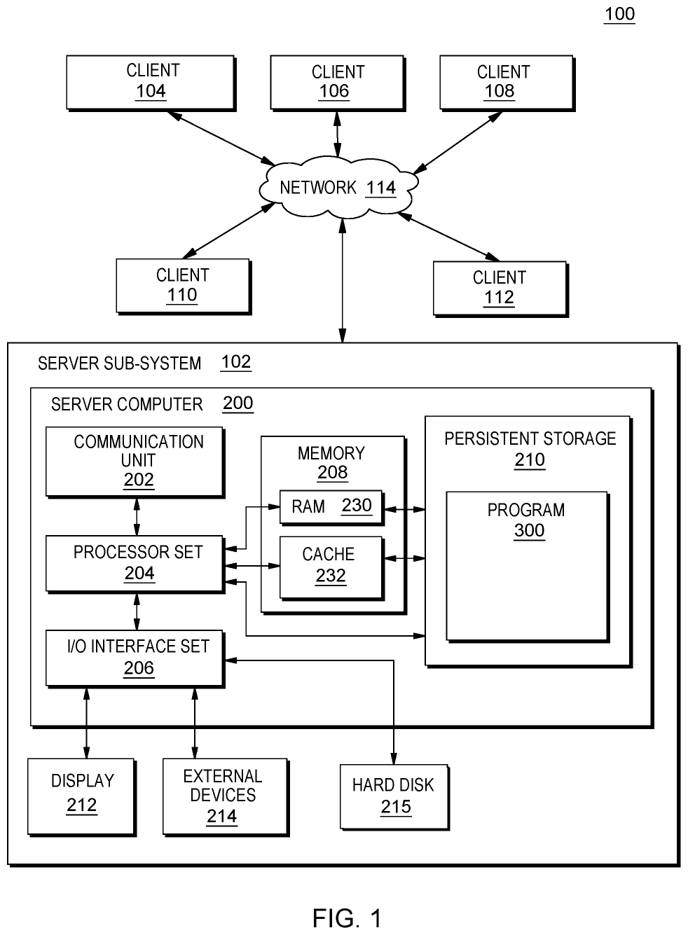

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; disk drive 215; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

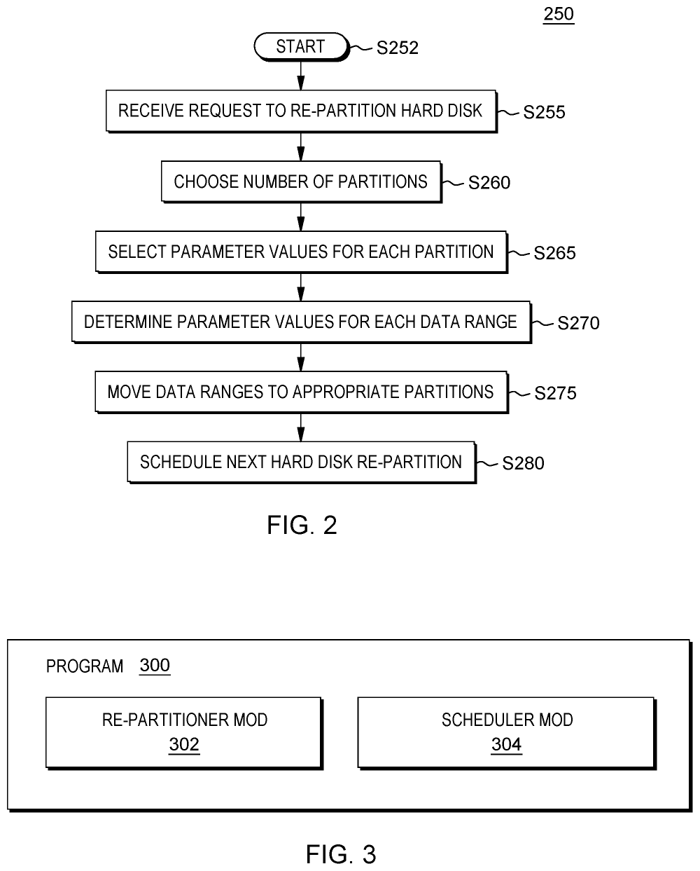

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at start operation S252.

Processing proceeds to operation S255, where re-partitioner mod receives a request to partition a hard disk storage device, with the hard disk drive storage device having stored thereon a plurality of data portions, with each data portion of the plurality of data portions including at least one bit of data.

Processing proceeds to operation S260, where re-partitioner mod 302 determines a number of partitions, N, to use in the requested partitioning operation, where N is an integer greater than one.

Processing proceeds to operation S265, where, for each given partition to be created responsive to the requested partitioning operation, determining a range of data access frequency and growth values characteristic of data to be stored in the given partition.

Processing proceeds to operation S270 where re-partitioner mod 302 performs the following sub-operations: (i) for each given data portion of the plurality of data portions, determining an associated access frequency value based on access operations that involved data included in the given data portion; and (ii) for each given data portion of the plurality of data portions, determining an associated growth value of each given data portion.

Processing proceeds to operation S275, where mod 302 re-partitions hard disk drive 215 based on the access frequency values and/or the growth values.

Processing proceeds to operation S280, where scheduler mod 304 schedules the next re-partitioning of hard disk 215.

### III. FURTHER COMMENTS AND/OR EMBODIMENTS

Some observations about the current state of technology in the area of the invention: (i) currently, partition tables are widely used in the database, but sometimes, the frequencies of the partition accessing are not the same and thus could use more efficient disk performance; (ii) currently, there are methods for partitioning by range and partitioning by growth, but there is no method for partition dividing by access frequency; (iii) uses a method to divide the index access depending on the access frequency; (iv) the partition table would be divided into several parts; (v) there is a table directory to control the partition dividing method; (vi) the partition table can be partitioned based, at least in part, on range; (vii) the partition table can be partitioned, based at least in part, by growth; (viii) usually, the hot data would be held in the faster disk as level 0; (ix) accessing statistic information for the page segment can be saved in the space map page; and (x) the database system would check the statistics and decide to save segments to certain partition(s).

An embodiment of a method according to the present invention includes the following operations (not necessarily in the following order): (i) Access frequency statistics collection; (ii) Divide the partition depending on the statistics; (iii) Register the method for partition table in the table directory page; (iv) Page segment registered in the page directory; and (v) Page segment moved between different disks. These five (5) operations will be discussed in the following paragraphs.

(i) Access frequency statistics collection: When there are access requests, the information could be collected for the usage of partition dividing. The collected information is saved in the page segment space map pages, table directory pages, and partition directory pages.

(ii) Divide the partition depending on the statistics: The partition is divided depending on the access frequency where the more frequency page segment would settle in the same partition.

(iii) Register the method for partition table in the table directory page: When the method for partition table is settled down, the information should be registered in the table directory page.

(iv) Page segment registered in the page directory: In the partition, the table is also settled as hot page segments, and the hotter page segment would be settled in the efficient disk.

(v) Page segment moved between different disks: The page segment could be moved as an entire storage between efficient disks and normal disks.

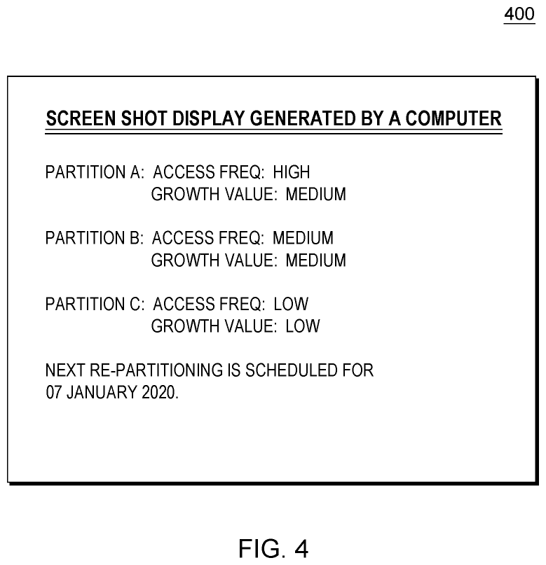

FIG. 4 shows screenshot 400, which is helpful in understanding various embodiments of the present invention.

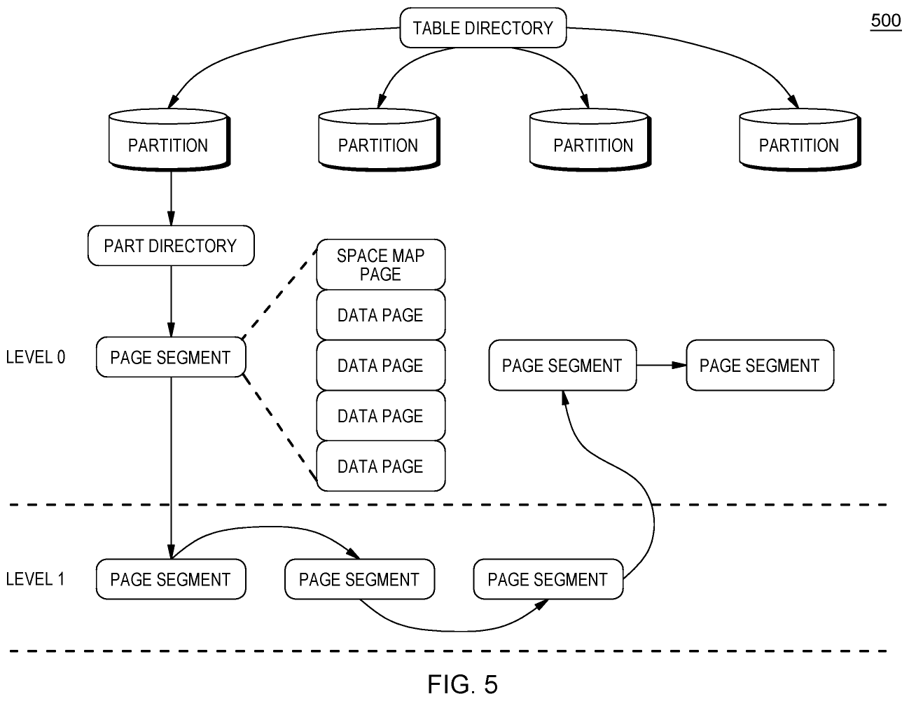

FIG. 5 shows block diagram 500, which is helpful in understanding various embodiments of the present invention.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Range of values: can be a single value (for example, a Boolean value of “true”), and the range may include more than one discrete value and/or more than one non-consecutive sub-ranges of values.

1. A computer-implemented method (CIM) comprising:
receive a request to partition a able of data for storage in a database as a partitioned table, with the table of data being divided into a plurality of page segments, with each given page segment being respectively characterized by an access frequency value reflecting how often data of the given page segment is expected to be accessed;
dividing the table of data into a number of partitions, N, the N partitions include: (i) at least one high efficiency partition stored on a high efficiency disk drive storage device, and (ii) at least one normal efficiency partition stored on a normal efficiency storage device;
for each given page segment of the plurality of page segments, determining an associated access frequency value for the given page segment based on access operations that involve data included in the given page segment;
storing the page segments having a relatively high access frequency values in the at least one high efficiency partition; and
storing the page segments having a relatively low access frequency values in the at least one normal efficiency partition.

2. The CIM of claim 1 further comprising:
register the at least one high efficiency partition and the at least one normal efficiency partition for the partitioned table in a table directory page.

3-12. (canceled)

13. A computer program product (CPP) comprising:
a set of storage device(s); and
computer code stored collectively in the set of storage device(s), with the computer code including data and instructions to cause a processor(s) set to perform at least the following operations:
receive a request to partition a table of data for storage in a database as a partitioned table, with the table of data being divided into a plurality of page segments, with each given page segment being respectively characterized by an access frequency value reflecting how often data of the given page segment is expected to be accessed,
dividing the table of data into a number of partitions, N, the N partitions include: (i) at least one high efficiency partition stored on a high efficiency disk drive storage device, and (ii) at least one normal efficiency partition stored on a normal efficiency storage device,
for each given page segment of the plurality of page segments, determining an associated access frequency value for the given page segment based on access operations that involve data included in the given page segment,
storing the page segments having a relatively high access frequency values in the at least one high efficiency partition, and
storing the page segments having a relatively low access frequency values in the at least one normal efficiency partition.

14. The CPP of claim 13 wherein the computer code further includes instructions for causing the processor(s) set to perform the following operation(s):
register the at least one high efficiency partition and the at least one normal efficiency partition for the partitioned table in a table directory page.

15. A computer system (CS) comprising:
a processor(s) set;
a set of storage device(s); and
computer code stored collectively in the set of storage device(s), with the computer code including data and instructions to cause the processor(s) set to perform at least the following operations:
receive a request to partition a table of data for storage in a database as a partitioned table, with the table of data being divided into a plurality of page segments, with each given page segment being respectively characterized by an access frequency value reflecting how often data of the given page segment is expected to be accessed,
dividing the table of data into a number of partitions, N, the N partitions include: (i) at least one high efficiency partition stored on a high efficiency disk drive storage device, and (ii) at least one normal efficiency partition stored on a normal efficiency storage device,
for each given page segment of the plurality of page segments, determining an associated access frequency value for the given page segment based on access operations that involve data included in the given page segment,
storing the page segments having a relatively high access frequency values in the at least one high efficiency partition, and
storing the page segments having a relatively low access frequency values in the at least one normal efficiency partition.

16. The CS of claim 15 wherein the computer code further includes instructions for causing the processor(s) set to perform the following operation(s):
register the at least one high efficiency partition and the at least one normal efficiency partition for the partitioned table in a table directory page.
